(19) United States
(12) Patent Application Publication
(10) Pub. No.: US 2007/0124675 A1
(43) Pub. Date: May 31, 2007

(54) Methods and systems for changing language characters of graphical and application interfaces

(76) Inventors: Oliver K. Ban, Austin, TX (US); Glenn D. Johnson, Hillsborough, NC (US); Shu-Chen Lim, Singapore (SG); John S. Maresca, Hopewell Junction, NY (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(21) Appl. No.: 11/289,106

(22) Filed: Nov. 29, 2005

(51) Int. Cl. G06F 9/00

(52) U.S. Cl. 715/703

(57) ABSTRACT

Methods and systems for changing language characters of graphical user interfaces and application programming interfaces are disclosed. Embodiments comprise a method of changing the characters of a first language displayed on a device interface screen to a second language upon activation of an element on the device. In some embodiments, the element for changing the language is a menu bar item. In one embodiment, the element for changing the language is a mechanical switch. In another embodiment, the element for changing the language of the displayed characters is a touch-screen target. Some embodiments comprise systems such as industrial and personal computers, while other embodiments comprise smaller electronic devices such as cellular telephones, handheld computers, and portable gaming devices.

### FIELD

The present invention generally relates to the fields of graphical user interfaces and application programming interfaces. More particularly, the present invention relates to methods, systems, and media for changing language characters displayed in graphical user interfaces and application programming interfaces.

### BACKGROUND

As personal computers (PCs), portable cellular telephones, handheld PCs, and other electronic devices have become more sophisticated over the years, user interfaces for these devices have also become more sophisticated. These user interfaces allow a user to interact with the electronic devices by inputting commands, inputting data, and receiving results from the commands and data. Of the various interfaces available, graphical user interfaces (GUIs) and application programming interfaces (APIs) have become very popular for interacting with these electronic devices, as well as operating and providing users access to device software and configuration.

A GUI screen generally presents a variety of information to the user, with the content of the GUI screen changing in various ways depending on the input made by the user and other factors. A large number of electronic devices today actually comprise a small central processing system running an operating system that generates and controls the GUI. Through a consistent interface of items such as windows, pull-down menus, and toolbars, GUI operating systems have simplified the use of electronic devices. These GUIs have also rendered the technology more “user friendly” by organizing the information contained in the devices in a logical manner and eliminating difficult tasks, such as requiring users to enter arcane and complex sets of keystrokes to either enter or retrieve data from the devices.

Conventionally, GUI screens are changed by switching between a plurality of GUI screens that are defined in advance. Each GUI screen is defined by specifying the shape, arrangement, and operation of the screen and the shapes, arrangements, and operations of all GUI elements. These GUI screens are then generally arranged and stored into memory elements of electronic devices, such as read-only-memory (ROM) or flash memory components, for later retrieval by the operating system.

In addition to providing a convenient method for displaying and scrolling information in windows or screens, GUIs also provide a simple method for executing various commands associated with user information. These commands are normally executed from a menu bar displayed across the top of the screen, or alternatively across the top of the application window, or executed from a toolbar comprising a plurality of push-button control icons associated with each command. The menu bar normally comprises a number of menu categories. For example, a menu bar on a handheld PC may contain categories of “File”, “Edit”, “Setup”, etc. Associated with each menu category may be a group of menu items or commands for manipulating user data. These menu items are normally displayed in a pull-down menu when the user selects a menu category from the menu bar with an input device, such as a keystroke of a keyboard or a click of a mouse button. For example, a menu bar on a cellular telephone may have a “Ring” menu category in order to display a pull-down menu comprised of various menu items for manipulating the format of the various ring tones that the telephone may activate. Each menu item may have a short title, for example “Volume”, “Ring Type”, etc., that helps identify the command associated with the menu item.

Many electronic devices are designed for use in a global economy, sometimes with millions of the devices being distributed throughout numerous countries of the world. In order to enhance marketability of electronic devices and to enable foreign users to efficiently interact with the devices, the graphical interfaces and screen displays of the device may need to appear in the language of the foreign user. Many device manufactures solve this problem by creating separate models with GUI screens customized for different languages. For example, a Japanese cellular telephone manufacturer may create one telephone model with GUI screens written only in Japanese and another model with GUI screens written only in English. However, such a business method can be expensive and time consuming, as it is then necessary to change or modify the GUI screens to create different models intended for distribution in other countries, or worse yet, create altogether different models with altogether with different GUI screens.

Many electronic device manufacturers approach the problem of creating devices for a global economy by creating a single device programmed in several languages. For example, a handheld PC manufacturer may create a single handheld PC model and store numerous sets of GUI screens encoded in separate languages, such as English, Chinese, Spanish, and Russian. When a user purchases and operates the PC, she may simply “select” a particular language that she desires. For example one model of a handheld PC may be distributed and sold in both China and in Australia. A user of the model purchased in China may select Chinese for the desired GUI screen system format. Alternatively, a user of the same model sold in Australia may select English for the desired GUI screen format language.

Most often, a user selects a desired GUI screen format language by navigating through a series of pull-down menu items. For example, a user may choose a “Format” menu bar category, from which numerous pull-down selection items are presented. One of the pull-down selection items may be a “Language” target submenu item. Upon selecting the “Language” target, a submenu pull-down list may further present a list of various languages from which one particular language may be selected. For example, the submenu list selection items may comprise “English”, “Chinese”, “Spanish”, and “Russian”. Keeping with our example noted above, a Chinese user may then select “Chinese”, while an Australian user would likely choose “English”. Upon selecting a GUI screen format language in this manner, the electronic device may then switch to the alternate display mode and present GUI screens formatted in the selected language.

This method of using menu bar and submenu bar items, however, has a seriously frustrating problem for many, if not most, users. Unless a user is multilingual, he may be scrolling through the various menu items and intentionally or unintentionally select a language that he cannot read. Once the electronic device starts presenting the GUI screens formatted in the alternate language, the user may have an extremely difficult time navigating the various GUI screens and menus to reselect a language he can read.

Presently, there are no elegant or even sufficient solutions to address this problem. Many electronic device manufacturers leave the user to fumbling around the GUI system menus until he reselects the desire language. Manufacturers that do acknowledge the problem and try to assist users in reselecting correct languages often choose one of two methods. In one method, manufacturers have the system default to a factory-selected “default” language once the system is forced through a hard reset, such as when operating power is removed for a period of time. This solution has some serious drawbacks though. One drawback is the fact that the user will often lose all personalized information stored in the device, such as date, time, or even addresses and telephone numbers. Another drawback may be the fact that the system default language may be one that the user does not recognize. For example, an Australian user that accidentally sets the GUI screen format language to Spanish from English, may be no better off if the system is reset and starts displaying the GUI system screens in Japanese.

In another method of addressing the GUI language selection problem, manufacturers may provide specific and detailed instructions for selecting a different language in the device user manual. Problems with this solution are readily apparent. For one, the user may have lost the manual a long time ago, before encountering the language selection problem. Even if the user does have the manual, he may not be able to readily locate it. Alternatively, the user may know precisely where the manual is, but may not know that the manual provides the solution. Even further, the user may be traveling and not have access to the manual.

There is therefore a long-felt need in the art for user-friendly methods and apparatuses for selecting GUI screen format languages. The methods and apparatuses of the present invention are readily adaptable to many types of electronic devices having GUI screens that may be displayed in more than one language.

### SUMMARY

The problems identified above are in large part addressed by methods and systems to change language characters displayed in graphical user interfaces and application programming interfaces. One embodiment comprises a method to change characters of one language on an interface screen to characters of another language when a user activates an element. One variation of the method provides that the display language may change to a third language when the user activates the element. Other variations of the method generally include changing the display characters from such languages as English and Chinese to such languages as Spanish and Russian. The elements for changing the language of the displayed characters may be targets selected on a touch-screen by a stylus, targets selected by a device key, or activating a mechanical switch.

Other embodiments comprise systems that change characters from one language to another language on a user interface screen. Some systems comprise user interface screens on cellular telephones, while other systems comprise screens on personal computers and portable game consoles.

A further embodiment comprises a machine-accessible medium containing instructions, which when executed by a machine cause the machine to change characters displayed on an interface from one language to another language in response to a person activating a readily accessible element of the machine.

### BRIEF DESCRIPTION OF THE DRAWINGS

Other objects and advantages of the invention will become apparent upon reading the following detailed description and upon reference to the accompanying drawings in which, like references may indicate similar elements:

FIG. 1 depicts an embodiment of a personal digital assistant (PDA) employing a concealed momentary switch for selecting a display language for the PDA GUI;

FIG. 2 depicts an embodiment of a graphical user interface (GUI) screen displaying screen items in English, employing a screen element for selecting a display language for the GUI;

FIG. 3 depicts an embodiment of a GUI screen displaying screen items in Chinese, employing a screen element for selecting a display language for the GUI;

FIG. 4 depicts an embodiment of a portable electronic gaming device employing a concealed momentary switch for selecting a number of different display languages for the device GUI;

FIGS. 5 & 6 depict a GUI window with option buttons for selecting a display language for an application programming interface and the GUI window;

FIG. 7 illustrates . . . .

FIGS. 8 & 9 depict a flowchart of an embodiment to select a display language for an application programming interface; and

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, methods, systems, and media for selecting display languages for graphical user interfaces (GUIs) and application programming interfaces (APIs) are disclosed. Embodiments comprise GUI and API screens which may be configured to display a variety of different languages, including one or more elements that a user may activate to select a display language. In some embodiments, the element for selecting the display language comprises an element displayed on the GUI or API screen. In other embodiments, the elements displayed on the GUI or API screens for selecting the display languages may be continually visible screen targets.

In some embodiments, the element displayed on the GUI or API screen to select a display language may be a continually visible menu bar item. In another embodiment, the element for may comprise a physical switch, recessed into a case of a device housing the GUI screen. Embodiments of this invention may be implemented in countless consumer electronic devices such as desktop and portable PCs, cellular telephones, point-of-sale terminals, Digital Versatile Disk (DVD) players, satellite receivers, digital cameras and video recorders, portable music players, and even watches. In different embodiments GUIs and APIs may be used to perform various tasks, such as device set-up, selection of operational functions, programming user preferences, and determining conditional access. Other tasks may include operating application programs, selecting audio and visual characteristics. In alternative embodiments, various media may store software for selecting a display language for GUI and API screens, such media as compact discs (CDs), digital versatile discs (DVDs), read-only-memory (ROM), and flash memory.

While portions of the following detailed discussion describe many embodiments comprising several specific methods for selecting a display language in GUIs and APIs, upon review of the teachings herein, a person of ordinary skill in the art will recognize that the display language may be selected using numerous slight variations of the methods discussed. One of ordinary skill in the art will recognize that such variations may substituted for these described methods and employed in accordance with similar constraints to perform substantially equivalent functions.

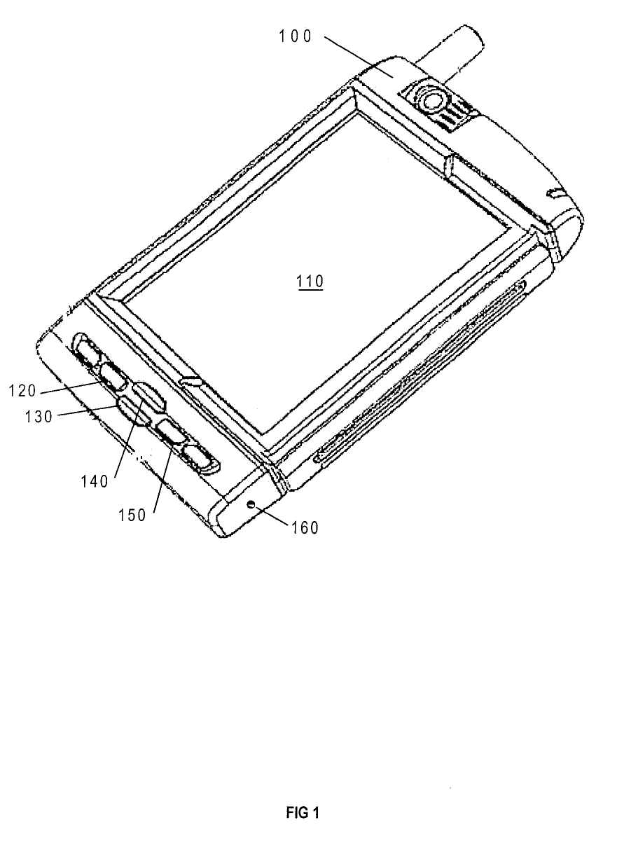

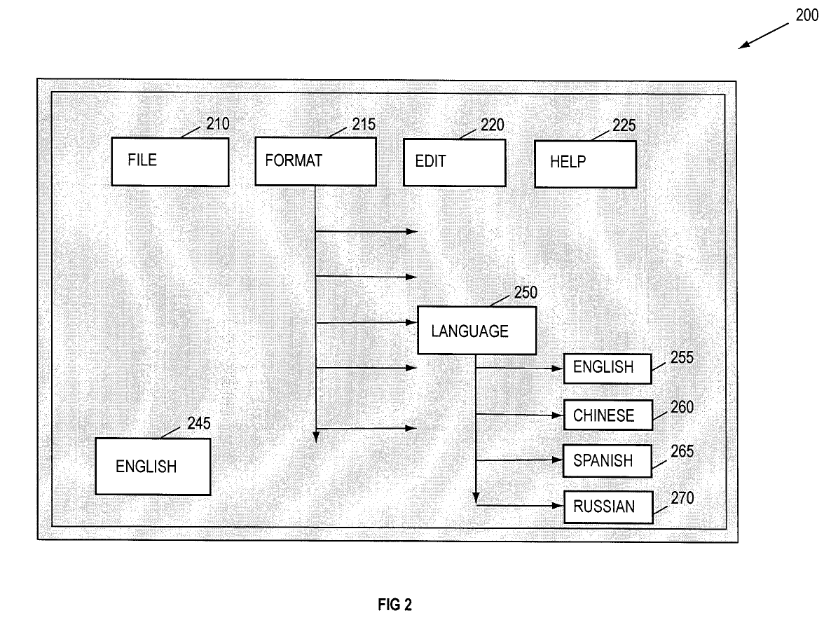

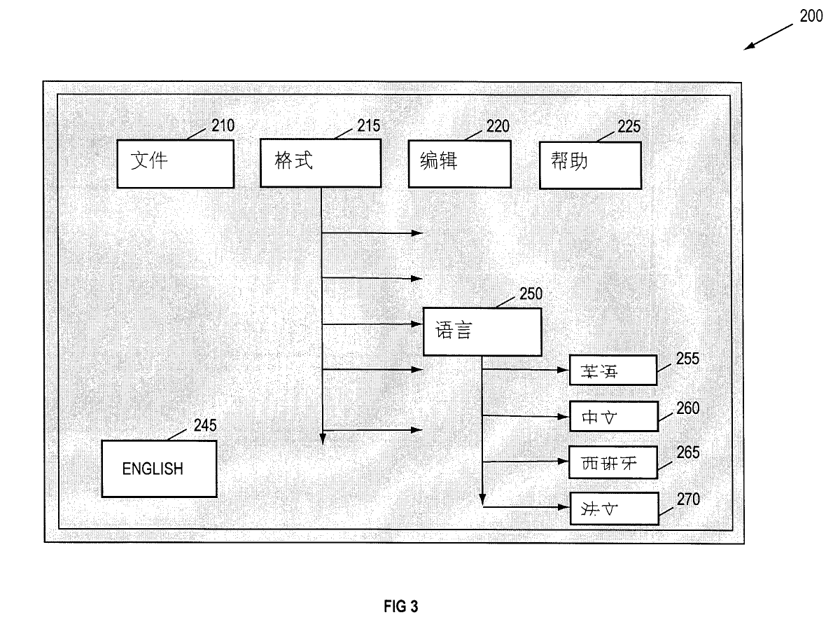

Turning to the drawings, FIG. 1 illustrates a system 100 which may employ several different embodiments for selecting a display language for a graphical interface. As depicted in FIG. 1, system 100 may comprise a wireless personal digital assistants (PDA) or other similar palm-held personal computing device, with a GUI screen 110. System 100 may employ a graphical menu system, comprising menu elements and submenu elements, similar to the embodiment that will be described in FIGS. 2 and 3. Such menu system may be navigated by pressing navigation keys 120, 150, 130, and 140, or the menu system may be navigated using a stylus.

In an alternative embodiment, system 100 may employ a hardware switch to select a GUI display language instead of a screen element. The hardware switch may be recessed, or concealed, to help prevent a user from accidentally activating it. For example, the switch may reside in an area that the user does not grasp or hold during normal use, such as an upper or lower location on one of the sides of system 100, or even on the rear of the system 100.

In FIG. 1, system 100 employs a recessed switch 160 on a lower corner side of system 100. In an alternative embodiment, switch 160 may not only be slightly recessed, but completely recessed into a relatively deep cavity of system 100, requiring a small tool, such as a small screwdriver, to be inserted in the cavity to activate it. Once depressed, switch 160 may cause system 100 to display all menu and display characters in a default language. The default language may be set at the factory at the time system 100 is manufactured. In an alternative embodiment, the default language may be selected by placing one or more dual-inline-package (DIP) switches into a certain configuration. In an even further embodiment, the default language to be selected by activating switch 160 may be configured in a non-volatile type of memory device, such as a UV-eeprom or flash memory. In some embodiments, this “configurable” default language may be changed by deliberate means, such as when upgrading and configuring the flash with a dedicated software program. For example, an external program running on a PC may be used to set a variety of system parameters for a portable or handheld system 100, such as the amount of available memory or the number of attached storage devices. Once such a default language is configured, by whatever means, switch 160 may be activated to select the default language and start displaying the characters on the GUI screen 110 in that language.

In alternative embodiments, switch 160 may serve dual or multiple purposes. For example, switch 160 may serve as both a system reset and as a language selection key for system 100. Switch 160 may serve in this dual or multiple capacity by altering the amount of time the user depresses switch 160 for each function. For example, the user may reset system 100 by momentarily depressing switch 160. Alternatively, the user may select a default language for system 100 by holding switch 160 down for 5 seconds. As discussed above, the default language to be activated by switch 160 may be fixed at the factory, and unchangeable, or configurable by a variety of deliberate means.

FIG. 2 illustrates a number of graphical user interface elements on a GUI screen 200. GUI screen 200 may be displayed on a variety of electronic devices. For example, GUI screen 200 may be shown on a PDA like system 100 in FIG. 1, a cellular telephone, or a portable gaming system, just to name a few. GUI screen 200 may have one or more menu bar elements, such as a menu bar “File” element 210, a menu bar “Format” element 215, a menu bar “Edit” element 220, and a menu bar “Help” element 225.

Note that in FIG. 2 menu bar “Format” element 215 is highlighted. In various embodiments, menu bar elements may be highlighted, or given focus, in a variety of different ways. For example, in some embodiments, a user may highlight a menu bar item by pressing a sequence of keys and then pressing an “Enter” key on a keyboard. Alternatively, other embodiments may employ a touch-screen GUI, wherein such menu items, or selectable screen targets, may be selected using a pen-type input device, such as a stylus of a PDA.

Once a screen target, or menu bar element is highlighted, or selected, a number of submenu bar elements may appear. For example, FIG. 2 depicts a possible scenario wherein a user has selected a submenu bar “Language” element 250, and the device controlling GUI screen 200 has accordingly highlighted “Language” element 250. Upon highlighting “Language” element 250, GUI screen 200 may then display several submenu bar sub-elements, such as “English” sub-element 255, “Chinese” sub-element 260, “Spanish” sub-element 265, and “Russian” sub-element 270. Again, FIG. 2 may depict a possible scenario wherein a user has selected “Language” element 250 and then selected “English” sub-element 255.

As a consequence of having chosen “English” sub-element 255, the device controlling GUI screen 200 may display all language characters on GUI screen 200 in English. Similarly, a user could have chosen another sub-element, such as “Chinese” sub-element 260. If the user chooses sub-element “Chinese” 260, the device may alter displayed language characters on GUI screen 200, such that the resulting user interface screen looks similar to FIG. 3. As shown in FIG. 3, the device may similarly alter displayed language characters to Chinese characters on GUI screen 200 for menu bar “File” element 210, menu bar “Edit” element 220, and menu bar “Help” element 225. While not depicted in FIG. 3, though, the device may also alter displayed language characters for all of the associated submenu bar elements.

In this particular embodiment, GUI screen 200 depicted in both FIG. 2 and FIG. 3 contains an “English” selection box 245. In this embodiment, as user could have alternately highlighted and selected this “English” selection box 245 to have the device display GUI screen characters as English characters. Worth emphasizing, for the embodiment depicted in FIG. 2 and FIG. 2, note that “English” selection box 245 has English language characters when English is selected as the desired language, as in FIG. 2, and also English language characters when Chinese is selected as the desired language, as in FIG. 3.

Displaying a consistent set of language characters in a dedicated language selection box, regardless of the language selected and activated by a user, may enable the user to easily alter the displayed language back to a language that the user can understand. For example, suppose that the user has accidentally selected Chinese as the display language for the device and GUI screen 200, similar to GUI screen 200 depicted in FIG. 3. Suppose further that the user can only read and understand English. Changing the display language characters for GUI screen 200 may be difficult for the user when trying to do so using the menu bar, submenu bar, and sub-elements depicted in FIG. 3, which are in Chinese. One may see how this problem may be even more difficult if the GUI screen 200 were to “clear” after the user had selected a sub-element menu item, which would require the user to navigate back to the correct menu, submenu, and sub-element item to rectify the problem of an incorrect language selection. Instead, according to the solution offered by this embodiment, the user may simply highlight and select the “English” selection box 245 to have the device redisplay GUI screen 200 characters as English characters.

Having the “English” selection box 245 characters displayed in English on GUI screen 200 at all times, regardless of the language configured for the rest of the system and regardless of what menu and submenu elements are highlighted, may allow for an intuitive and user-friendly method for the user to configure the display language for the device and GUI screen 200. For example, imagine that the user jumped to a different menu and submenu element, such as a “Save” submenu element under menu bar “File” element 210, after choosing sub-element “Chinese” 260 and altering the display language characters on GUI screen 200 to Chinese. Since the menu and submenu elements would be displayed in Chinese, the user would likely have a difficult time navigating back to the menu bar “Format” element 215 and choosing sub-element “English” 255. Fortunately, in this embodiment, the user would not have to navigate to another menu bar element to change the display language back to English. The user would simply highlight and select “English” selection box 245, which would be displayed on GUI screen 200 with English characters.

In some embodiments, GUI screen 200 may contain menu bar elements located at the top of the screen, such as the manner in which the menu bar elements are positioned in FIG. 2. In other embodiments, menu bar elements may be located at the bottom or side. In further embodiments, menu bar elements may even be hidden until a user activates a designated element on an electronic device, such as a keypad key or a pointer control button. Also, while the embodiment depicted in FIG. 2 displays boxed text menu bar items, other embodiments may display other shapes for menu bar items and screen targets, such as rounded rectangles and ellipses. Additionally, graphic or pictorial elements may accompany the menu bar items. In even further embodiments, the menu bar items may simply comprise text without any graphics.

GUI screen 200 may also include one or more scroll bars, such as a vertical scroll bar or a horizontal scroll bar. For example, the scroll bar may include controls for incrementally scrolling up or down GUI screen 200. In such case, a user may simply use the scroll bar to move to the portion of the window containing “English” selection box 245 and then highlight and select it to cause the characters on GUI screen 200 to be displayed as English characters. In even further embodiments, the default or base language can be a language other than English. For example, “English” selection box 245 may instead be a “Spanish” or a “Chinese” selection box, which would convert the displayed characters to Spanish or Chinese, respectively.

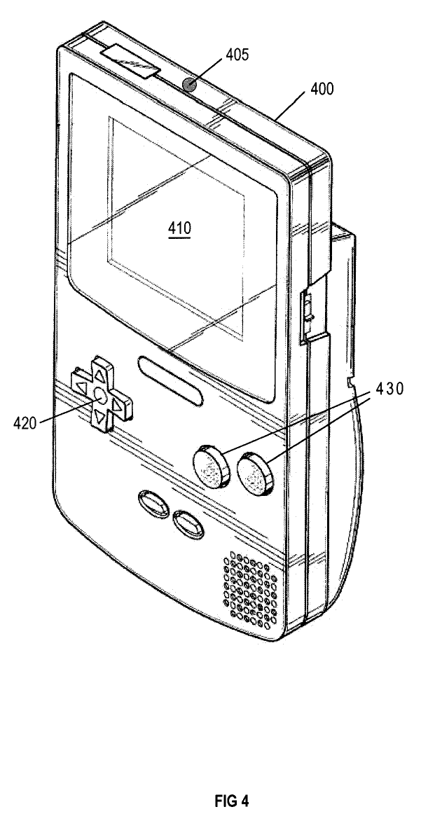

Turning now to FIG. 4, there is shown an embodiment of a different type of system, more specifically a portable game console 400. Similar to the aforementioned embodiments, portable game console 400 contains a GUI screen 410, a joystick or cursor control component 420, and function keys 430. Again similar to the embodiments discussed for FIGS. 1, 2, and 3, portable game console 400 may be configured or programmed to display various graphics and menu systems using a variety of different language characters on GUI screen 410. Unlike the previous figures and associated discussions, however, the embodiment described for this system may have certain benefits, depending on the circumstances. For instance, portable game console 400 may have a severely limited menu system, being geared more toward playing games than for more productive activities. Additionally, manufacturers of a game console such as portable game console 400 may be unwilling to dedicate a portion of GUI screen 410 for continuously displaying a language selection target on GUI screen 410, due to the already limited screen size and interference with other functions, such as playing games. Even further, portable game console 400 may not have dedicated components for selecting and storing a “default” language, such as flash memory components and DIP switches. Accordingly, manufacturers of portable game console 400 may opt for a slight variation of the embodiments discussed thus far.

Manufacturers of portable game console 400 may employ a recessed switch 405 for selecting a different display language. Recessed switch 405 may function similar to switch 360 as shown and described in FIG. 3, changing the display language characters to a pre-selected default language. Alternatively, however, switch 405 may be configured to simply cause portable game console 400 to display a different set of language characters for each triggering of switch 405.

For example the portable game console 400 may start displaying Japanese characters when it is turned on straight out of the box. A Russian user, who cannot read Japanese, may desire to change the display language. The user may activate switch 405 one time, and force portable game console 400 to start displaying the characters in English. Assuming the Russian user cannot read English either, the user may then activate switch 405 a second time, forcing portable game console 400 to start displaying the characters in the desired language format, Russian. Alternatively, the Russian user could continue activating switch 405 until the user finds a suitable set of language characters. The underlying software and hardware for selecting the various languages may be configured to continually cycle through the list of available languages with each until a language is selected. For example the sequence of the cycle may look something like “English->Spanish->Chinese->Russian->English->Spanish-> . . . ”, etc.

One benefit of employing a switch 405 as a multiple-setting switch to select different languages in this fashion may be the benefit of having uninterrupted play. For example, if the display characters are accidentally changed to an alternate language during play using joystick or cursor control component 420 and function keys 430, the user may pause the game and activate switch 405 to select the desired language. This process of selecting a different language format may be configured to retain the game status items in memory, such as score and level, whereupon the user may then resume his game after changing the display language.

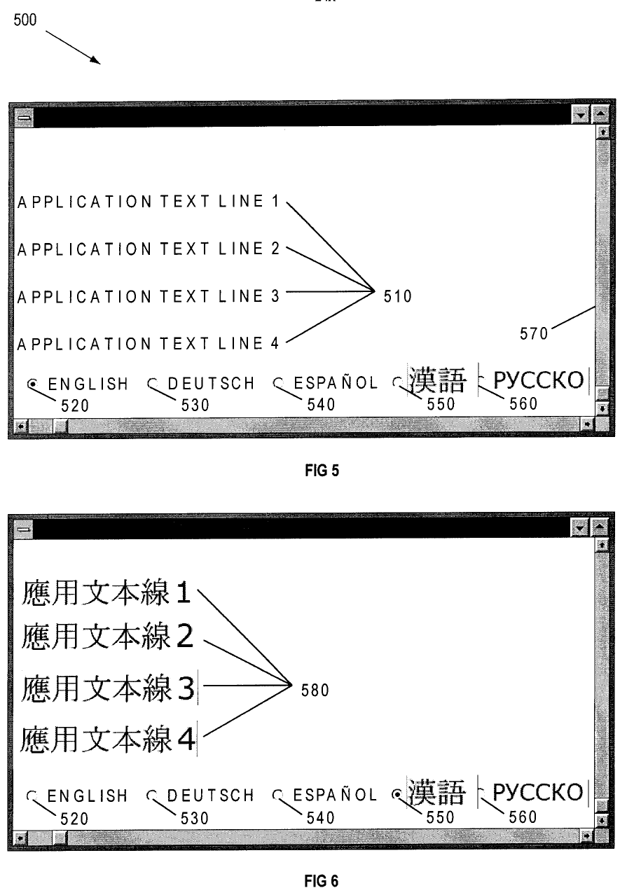

To provide yet another example embodiment, we turn to FIG. 5 which depicts a GUI window 500 with option buttons for selecting a display language for an application programming interface and the GUI window. FIG. 5 shows GUI window 500 with several lines of text 510 displayed in English. GUI window 500 may comprise a database application window on a personal PC, a text file window on a palm-held computing device, or a general application window on a laptop. GUI window 500 may have a row of option buttons for selecting a different display language, such as English option button 520, German option button 530, Spanish option button 540, Chinese option button 550, and Russian option button 560. Various embodiments may have fewer or more option buttons for selecting fewer or more display languages. Additionally, alternative embodiments may use toggle buttons, check boxes, a combination box, or a list box to select the display language. The row of option buttons for selecting different display languages may be located at the bottom of the window, which may be scrolled to using scroll bar 570. In other embodiments, the row of option buttons may be located in other locations of the window, such as at the top.

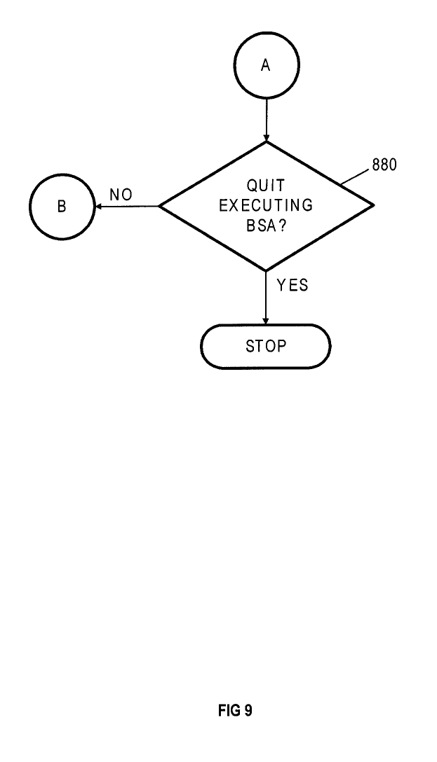

With the English option button 520 highlighted, or selected, the several lines of text 510 may be displayed in English, as in FIG. 5. A user may use a mouse pointer and select the Chinese option button, to convert the display language of the several lines of text to Chinese. This action may result in the display of element 580 in FIG. 6. Note that the English option button 520 is no longer selected, the Chinese option button is highlighted, and that the several lines of text 510 are now displayed in Chinese (element 580). This converting and displaying text may occur as a result of a display language command issued to an underlying application programming interface, such as the process which will be described for FIGS. 8 and 9. According to the embodiment shown in FIGS. 5 and 6, the user may immediately select another display language by selecting another language option button with the mouse. Worth additional emphasis, the row of option buttons in GUI window 500 retain their original text format regardless of the language selected, facilitating an easy and user-friendly method for switching between various display languages.

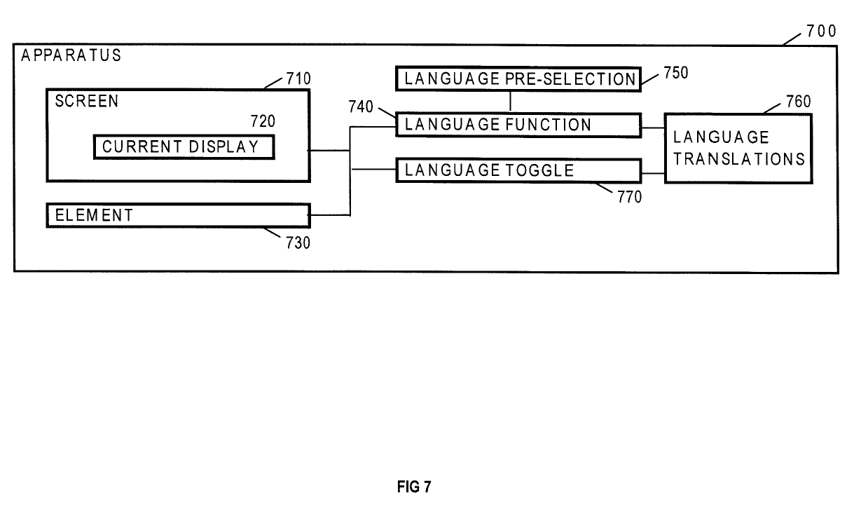

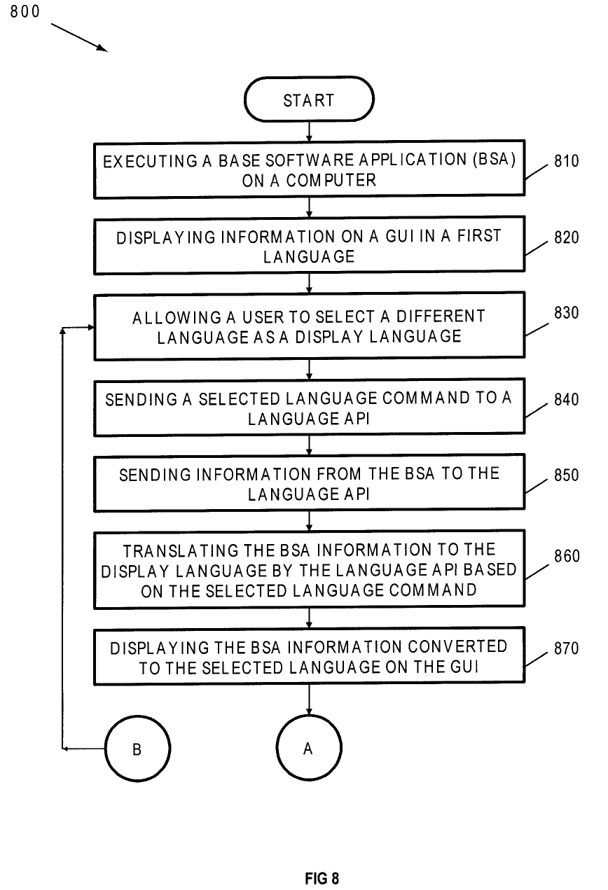

FIG. 7 illustrates an apparatus employing one embodiment for changing, or toggling, language characters on a screen. Apparatus 700 may comprise a part of various systems, including such systems as the PDA of FIG. 1, the game console of FIG. 4, a laptop computer, or a point-of-sale terminal. As shown in FIG. 7 apparatus 700 may employ a screen 710 for generating and displaying language characters on a current display 720.

When the device employing apparatus 700 is first powered up, a language pre-selection element 750 may provide information indicating the default language to a language function element 740. Based on the pre-selected language, language function element 740 may generate and transmit characters of a default language on an initial power-up display, which may be the current display 720. A user of the device may select a different display language by selecting, or activating, an element 730. Similar to previous embodiments, element 730 may comprise a hardware switch located somewhere on the device or a target displayed on the current display 720. The activation of element 730 may transmit a signal to a language toggle element 770. Upon receiving this signal, language toggle element 770 may then work in conjunction with language element 740 and a language translations element 760 to translate the characters to an alternate language, and display the characters of the alternate language on the current display 720. This translating of characters to the alternate language may continue as the user pages through various menu displays that are generated by the language function element 740 and sent to screen 710 and then made the current display 720.

In a variation of the embodiment, a user may have selected another display language after power-up, such that the current display 720 is in a language unintelligible by the user. Regardless of the current display language, the user may then select element 730 to activate language toggle element 770. Language toggle element 770 may then work in conjunction with language function element 740, and possibly language translations element 760 if necessary, to display the pre-selected language indicated by language pre-selection element 750 on the current display 720. In this variation of the embodiment, element 730 may be equivalent to a “language reset,” changing the display language back to the pre-selected language as indicated by language pre-selection element 750. In an even further embodiment of this variation, the default language of language pre-selection element 750 may be selectable by hardware, such as with a configuration of DIP switches, or selectable by software and stored in nonvolatile memory.

FIG. 8 and FIG. 9 depict a flowchart 800 of an embodiment to select a display language for an application programming interface, or API. An embodiment according to flowchart 800 begins with executing a base software application (BSA) on a computer (element 810). For example, the base software application may be a program operating in a point-of-sale terminal in a department store. In such a case, the computer may be a local computer networked with other point-of-sale terminals, or the computer may be a server located in a computer room of the department store. Alternatively, the base software application may be a computer based training application in an educational facility. In this case, the computer may be a standalone personal computer.

An embodiment of flowchart 800 continues by displaying information on a graphical user interface screen, or GUI, of the computer in a first language (element 820). In some embodiments, the first language may be a default language, such as Russian. In alternative embodiments, the first language may be the language that was last displayed when the BSA was executed. Accompanying the information on the GUI displayed in the first language may be a screen target or menu item immediately allowing a user to select a different display language (element 830). For example, if the information on the GUI screen is initially Russian, the user could select or activate a screen target or menu item to change the display language of the information on the GUI screen from Russian to Chinese.

A system according to the embodiment of FIG. 8 may proceed by sending a command to a language API, indicating the desired display language the user has selected (element 840). This command may simply be a code corresponding to the selected display language. For example, if the user continues in Russian, the corresponding language command transmitted may be a “1”. Alternatively, if the user instead selects Chinese as the display language, the corresponding language command transmitted to the language API may be a “2”. Transmitting the selected language command to the language API may be automatically transmitted on a set period or frequency, as would be the case with a subroutine executed periodically, or the command my be event based and only transmitted when the selected language changes.

The embodiment of FIG. 8 may continue by sending information from the BSA to the language API (element 850). Upon receiving the information sent from the BSA, the language API may translate the information to the selected display language, based on the selected language command (element 860). This translated display information sent from the BSA to the language API and converted into the proper display language may then be displayed on the GUI (element 870). For example, the base software application may send information to be displayed on the GUI to the language API. This information may be formatted in Russian. If the user has selected Chinese as the display language, the language API may translate the information from Russian into Chinese. After converting the information into Chinese, it may be displayed on the GUI. Alternatively, if the user left Russian as the display language, the language API would not need to translate the information sent from the base software application and may pass it directly to the GUI, unaltered.

This process of sending information from the BSA to the language API, converting the information into the selected display language, and displaying the converted information on the GUI may comprise the bulk of the system activity, with the language selection only occurring during the initial execution of the base software application. This sequence may be continually repeated as long as the user continues using the system and base software application (element 880), as depicted in FIG. 9. However, implicit in the process of converting and displaying the information is the continuously available option the user has of selecting a different display language (element 830). In other words, the user may change the display language at almost any time, whereupon the language API may simply convert the information to the newly selected language before displaying it on the GUI screen (elements 840 through 870). For an example visual representation, or possible graphical implementation, of this process one may refer back to the embodiment described in FIG. 5.

Another embodiment of the invention is implemented as a program product for use with a system to display languages on a GUI or in conjunction with an API in accordance with, e.g., flowchart 800 as shown in FIGS. 8 and 9. The program(s) of the program product defines functions of the embodiments (including the methods described herein) and can be contained on a variety of data and/or signal-bearing media. Illustrative data and/or signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such data and/or signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by a computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It will be apparent to those skilled in the art having the benefit of this disclosure that the present invention contemplates methods and apparatuses for selecting display languages in graphical user interfaces and application programming interfaces. It is understood that the form of the invention shown and described in the detailed description and the drawings are to be taken merely as examples. It is intended that the following claims be interpreted broadly to embrace all the variations of the example embodiments disclosed.

Although the present invention and some of its advantages have been described in detail for some embodiments, it should be understood that various changes, substitutions and alterations can be made herein without departing from the spirit and scope of the invention as defined by the appended claims. Further, embodiments may achieve multiple objectives but not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method to return a display on a screen of a device to a pre-selected language, the method comprising:
enabling access for a user of the device to an element in more than one navigable displays for the screen; and
linking activation of a language function with activation of the element of the user interface, wherein the language function is adapted to switch from a current language associated with a current display of the more than one navigable displays on the screen to the pre-selected language.

2. The method of claim 1, further comprising linking activation of a language toggle function to more than one activations of the element, wherein the language toggle function is adapted to toggle the display on the screen to another language.

3. The method of claim 2, wherein linking activation of the language toggle function comprises linking the more than one activations to a Chinese language.

4. The method of claim 1, further comprising enabling selection by a user of the pre-selected language.

5. The method of claim 4, wherein enabling selection by a user of the pre-selected language comprises enabling selection by the user of a Spanish language as the pre-selected language via a user interface.

6. The method of claim 1, wherein enabling access comprises displaying the element on the screen as a touch-screen target element.

7. The method of claim 1, wherein enabling access comprises designating a key on the device as the element.

8. The method of claim 1, wherein linking activation of the language function comprises linking activation of the element to responsively switch from the current language to an English language.

9. The method of claim 1, wherein linking activation of the language function comprises linking activation of the element to responsively switch from the current language to a Russian language.

10. The method of claim 1, wherein linking activation of the language function comprises linking activation to selection of a target element on the screen.

11. The method of claim 10, wherein linking activation to selection of the target element on the screen comprises linking activation to selection of a touch-screen target element with a stylus.

12. The method of claim 10, wherein linking activation to selection of the target element on the screen comprises linking activation to selection of the target element on the screen by depressing at least one key on the device.

13. A system to change a plurality of characters of a current language to a pre-selected language, the system comprising:
a screen to display the plurality of characters of the current language and the pre-selected language; and
an element to switch the current language associated with a current display of more than one navigable displays to the pre-selected language in response to activation, wherein the element is accessible for activation while the device is to display one of the more than one navigable displays on the screen.

14. The system of claim 1, further comprising a language toggler to toggle the display on the screen to another language in response to more than one activations of the element.

15. The system of claim 13, wherein the element comprises a touch-screen target of a touch screen.

16. The system of claim 13, wherein the element comprises a key on the device.

17. The system of claim 13, wherein the element comprises a menu selection item.

18. A machine-accessible medium containing instructions, which when executed by a machine cause the machine to change characters displayed on an interface, comprising:
enabling access for a user of the device to an element in more than one navigable displays for the screen; and
linking activation of a language function with activation of the element of the user interface, wherein the language function is adapted to switch from a current language associated with a current display of the more than one navigable displays on the screen to the pre-selected language.

19. The machine-accessible medium of claim 18, wherein the operations further comprise linking activation of a language toggle function to more than one activations of the element, wherein the language toggle function is adapted to toggle the display on the screen to another language.

20. The machine-accessible medium of claim 18, wherein linking activation of the language function comprises linking activation to display a second plurality of characters in response to user selection of target element of a touch screen via a stylus.
